(19) United States
(12) Patent Application Publication
(10) Pub. No.: US 2003/0086112 A1
(43) Pub. Date: May 8, 2003

(54) Image processing device, image forming apparatus, image processing system and image processing method capable of effective re-output of image data

(75) Inventors: Masaya Hashimoto, Osaka-shi (JP); Hiroshi Murakami, Osaka-shi (JP); Hiroyasu Ito, Osaka-shi (JP); Kazuhiro Araki, Osaka-shi (JP)

Correspondence Address: Barry E. Bretschneider, Morrison & Foerster LLP, Suite 300, 1650 Tysons Boulevard, McLean, VA, 22102, US

(73) Assignee: MINOLTA CO., LTD., Osaka-shi (JP)

(21) Appl. No.: 10/283,180

(22) Filed: Oct. 30, 2002

(30) Foreign Application Priority Data
Nov. 5, 2001 (JP) 2001-339356

(51) Int. Cl. G06F 3/12; G06F 15/00; G06F 13/00

(52) U.S. Cl. 358/1.14; 358/1.15; 358/1.16

(57) ABSTRACT

An image processing device capable of re-outputting as many image data sets as possible without increasing the required storage capacity of a storage device, by receiving from an external terminal image data obtained as a result of conversion of base data created using an application software program into a prescribed output format, outputting the received image data, storing identification information regarding the output image data in a storage device, instructing the external terminal to re-create the image data via activation of the application software program based on the identification information when an instruction to re-output the image data is input, receiving the image data recreated by the external terminal based on the instruction, and outputting the received image data.

This application is based on Japanese Patent Application No. 2001-339356 filed in Japan on Nov. 5, 2001, the entire content of which is hereby incorporated by reference.

### BACKGROUND OF THE INVENTION

1. Field of the Invention

The present invention relates to an image processing device such as a print controller, an image forming apparatus including such image processing device, an image processing system including such image processing device, and an image processing method that is executed using such image processing device.

2. Description of the Related Art

A printer system is known in which image data sent from an external terminal such as a personal computer and output from a printer is stored in the printer's storage device, and upon receiving an instruction to re-output the image data as in the case of memory recall, the image data is read out from the storage device and re-output by the printer.

Because the storage capacity of the storage device is limited, however, the number of image data sets that may be stored therein is limited. Accordingly, the problem arises that the number of image data sets that may be re-output is also limited.

Therefore, in the conventional art, a printer system has been proposed wherein image data output from the printer is stored not in the storage device of the printer, but in the storage device of the external terminal, and upon receiving an instruction for re-output, the image data is read out from the external terminal and re-output from the printer (Japanese Laid-Open Patent Application H12-103125). Another printer system has also been proposed wherein image data generated by a front-end processor is stored in a back-end processor, such that the image data can be re-output without being sent from the front-end processor (Japanese Laid-Open Patent Application H10-166688).

Incidentally, base data that was created by an external terminal using an application software program such as Word, Excel (which are both product names) or a text editor is stored in the storage device of the external terminal as a Word, Excel or text-format file. When such base data is sent to a printer for the purposes of printing, it must be opened using the application software program and converted into an image data format such as PostScript® or PCL.

In the conventional systems described above, the printed image data, i.e., the image data obtained as a result of the conversion into PostScript® or PCL format, is stored in the storage device of the external terminal. Consequently, the problem arises that because the post-conversion image data in PostScript® or PCL format is stored in the external terminal in addition to the base data, the available storage capacity of the storage device of the external terminal is reduced to that extent.

### OBJECT AND SUMMARY

An object of the present invention is to provide an improved image processing device, etc. that resolve the various problems identified above.

Another object of the present invention is to provide an image processing device, etc. that can re-output as many image data sets as possible without increasing the required storage capacity of the external terminal storage device.

These various objects are attained by providing an image processing device comprising receiving means that receives from an external terminal image data obtained as a result of conversion of base data created using an application software program into a prescribed output format; output means that outputs the received image data; storage means that stores identification information regarding the image data output by the output means; re-creation instruction means that, when an instruction to re-output the image data is input, instructs the external terminal to re-create the image data via activation of the application software program based on the identification information; and output control means that causes the receiving means to receive the image data re-created by the external terminal based on the instruction from the re-creation instruction means and causes the output means to output the image data.

This image processing device receives image data obtained as a result of conversion of base data created using an application software program into a prescribed output format from an external terminal, and outputs the received image data via the output means. When this is done, identification information for the output image data is stored in the storage means. When an instruction to re-output the image data is input by the user, the image processing device instructs the external terminal to re-create the image data based on the identification information by activating the application software program. Upon receiving this instruction, the external terminal re-creates the image data and sends it to the image processing device. The image processing device receives this image data and outputs it via the output means.

Because the external terminal is caused to re-create image data obtained as a result of conversion of base data when a re-output instruction is received, the image data can be re-output without the need to store previously output image data in the storage means of the image processing device or the storage means of the external terminal for re-output purposes. Moreover, because the size of an identification information data set that is stored in place of an image data set is smaller than that of the corresponding image data set, a larger number of identification information sets can be stored than is possible when image data sets are stored, enabling re-output of a large number of image data sets.

In this image processing device, the image data output by the output means may comprise print data, and the identification information may comprise identification information for the output print data. In this case, print data can be re-output without being stored in any storage means. It is preferred in this case that the identification information include information regarding the sender of the image data, information regarding the base data, and information regarding the application software program used to create the base data. Consequently, specification of the base data, etc. and re-creation of the print data through the conversion of the base data become easy.

In addition, the image processing device described above can also include detection means that detects the remaining storage capacity of the storage means and switching means that switches between storage of the output image data itself or storage of identification information regarding the output image data based on the detection result obtained by the detection means. Using this construction, where the storage means has sufficient remaining storage capacity, the output image data itself is stored, while where the storage means does not have sufficient remaining storage capacity, the choice of stored data can be switched to identification information, enabling effective data handling in accordance with the available storage capacity.

In addition, the image processing device described above can further include power supply detection means that detects whether the power supply to the external terminal is ON or OFF, and power supply control means that, when the power supply to the external terminal is OFF, turns it ON to begin the operation of the external terminal, and turns the power supply to the external terminal OFF after image data re-created by the external terminal based on the instruction from the re-creation instruction means has been received by the receiving means. Using this construction, even where the power supply to the external terminal is OFF, it is automatically turned ON and the operation of the external terminal is begun, such that the image data can be re-created by the external terminal based on the instruction from the re-creation instruction means.

The various objects described above are also attained by an image forming apparatus including an image processing device having any one of the constructions described above and a printer that prints out image data output from the output means of the image processing device. Using this image forming apparatus, image data that has been printed can be printed again without being stored in the storage means.

The various objects mentioned above are also attained by providing an image processing system including an image processing device and an external terminal that are mutually interconnected over a network, wherein the external terminal includes base data creation means that creates base data using an application software program, image data conversion means that converts this base data into image data having a prescribed output format, and re-creation execution means that executes the re-creation of the image data based on an instruction from the image processing device, and the image processing device includes receiving means that receives the image data from the external terminal, output means that outputs the received image data, storage means that stores identification information regarding the image data output by the output means, re-creation instruction means that, when an instruction to re-output the image data is input, instructs the re-creation execution means of the external terminal to re-create the image data based on the identification information, and output control means that causes the receiving means to receive the image data re-created by the external terminal and causes the output means to output the image data.

In this image processing system, the external terminal creates base data using an application software program and creates image data by converting the base data into a prescribed output format. The image processing device receives this image data and outputs the received image data via the output means. When this is done, identification information regarding the output image data is stored in the storage means. When an instruction to re-output the image data is input by the user, the image processing device instructs the external terminal to re-create the image data, based on the identification information, by re-activating the application software program. Based on this instruction, the external terminal re-creates the image data and sends it to the image processing device. The image processing device receives the re-created image data and outputs it via the output means.

The various objects described above are also attained by providing an image processing method that is executed by an image processing device, such method comprising (1) a step of receiving from an external terminal image data obtained as the result of conversion of base data created using an application software program into a prescribed output format; (2) a step of outputting the received image data; (3) a step of storing identification information regarding the output image data in storage means; (4) a step of instructing the external terminal to re-create the image data based on the identification information by activating the application software program when an instruction to re-output the image data is input; (5) a step of receiving the image data re-created by the external terminal based on the instruction issued in step (4); and (6) a step of outputting the image data received in step (5).

In this image processing method, when an instruction to re-output image data is input, the external terminal is instructed to re-create it by activating an application software program based on identification information. Based on this instruction, the external terminal re-creates the image data and sends it to the image processing device. The image processing device receives the image data and outputs it.

### BRIEF DESCRIPTION OF THE DRAWINGS

These and other objects and features of the present invention will become clear from the following description taken in conjunction with the preferred embodiments thereof with reference to the accompanying drawings, in which:

FIG. 1 is a block diagram showing a print system comprising one embodiment of the image processing system pertaining to the present invention;

FIG. 2 is a block diagram showing the specific construction of an external terminal and printer;

FIG. 3 is a flow chart showing the main routine of the processes executed by the control unit of a print controller when image data is to be re-printed;

FIG. 4 is a flow chart showing an image data storage processing subroutine;

FIG. 5 is a flow chart showing an external terminal power supply control processing subroutine;

FIG. 6 is a flow chart showing a re-output processing subroutine;

FIG. 7 is a table showing one example of the identification information; and

FIG. 8 is a flow chart showing the processing executed by the external terminal after receipt of an instruction to re-create image data.

### DETAILED DESCRIPTION OF THE PREFERRED EMBODIMENTS

An embodiment of the present invention is described below with reference to the drawings.

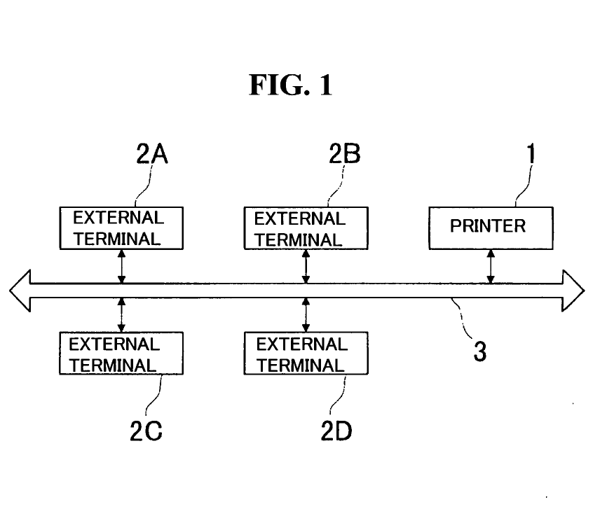

FIG. 1 is a block diagram showing the construction of a print system comprising one embodiment of the image processing system pertaining to the present invention.

As shown in FIG. 1, this print system comprises a plurality of external terminals 2A-2D consisting of personal computers or the like and a printer 1, which serves as an image forming apparatus, and these apparatuses are mutually interconnected over a network 3.

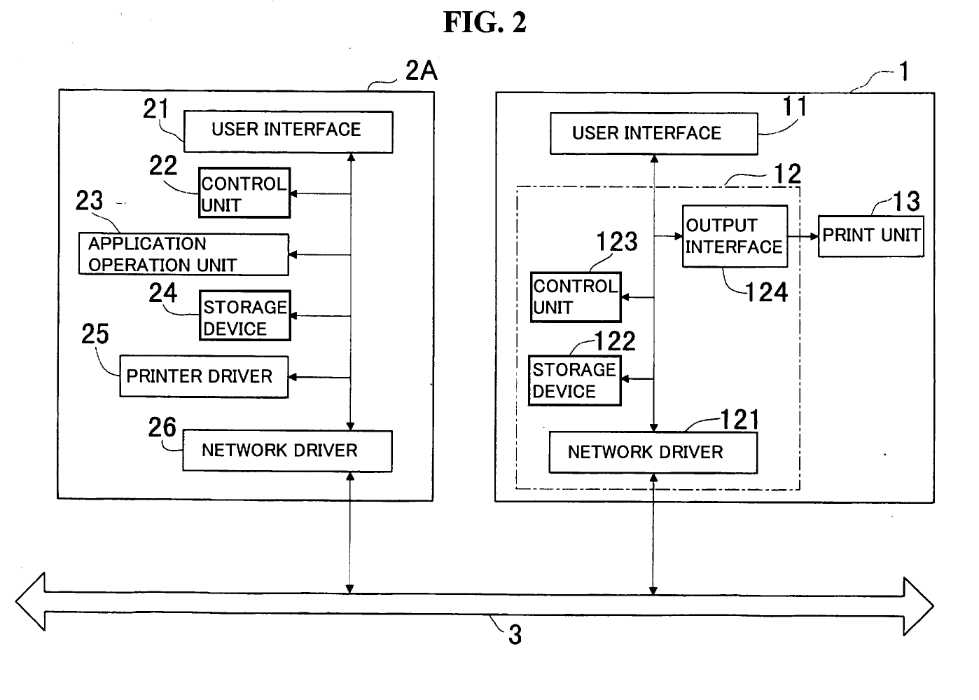

FIG. 2 is a block diagram showing the specific construction of the external terminal 2A and the printer 1. The external terminal 2A includes a user interface 21 that includes operation units such as a keyboard, a control unit 22, an application operation unit 23, a storage device 24 comprising a hard disk device or the like, a printer driver 25 and a network driver 26.

The user can use an application software program to create a document file, which serves as base data, by activating the application operation unit 23 through operation of the user interface 21. Word processing software programs (such as Word), spreadsheet software programs (such as Excel) and text editors are available as application software programs, and files created by using these application software programs are stored in the storage device 24 in the Word format (*.doc), Excel format (*.xls) and text format (*.txt), respectively.

When the user inputs a print instruction by operating the user interface 21 in order to print out a file via the printer 1, the application operation unit 23 converts the created file into image data such as data in PostScript® format or PCL format, for example, via the printer driver 25, and forwards it to the printer 1 via the network driver 26, which serves as a transmitter/receiver. Image data is converted in this way because if a file in the Word, Excel or text format were forwarded to the printer 1 unchanged, the printer 1 would not be able to read the file.

The control unit 22 performs overall control of the operation of the external terminal 2A. Specifically, it issues commands to the application operation unit 23 to create a file, to convert the created file into image data (print data), to send the image data to the printer, to re-create image data, etc.

The construction of each of the other external terminals 2B-2D is identical to the construction of the external terminal 2A.

On the other hand, the printer 1 includes a user interface 11 that includes operation units such as an operation panel, a print controller 12, which serves as an image processing device, and a print unit 13.

The user interface 11 is used by the user to operate the printer 1. The user can perform input by using the user interface 11 to issue an instruction for the re-output of image data that has previously been printed out. It is also acceptable if an instruction for re-output is input from any of the external terminals 2A-2D via the network 3.

The print controller 12 controls the overall operation of the printer 1, and includes a network driver 121, a storage device 122, a control unit 123 and an output interface 124.

The network driver 121 functions as a transmitter/receiver to transmit and receive data to and from the network 3.

The storage device 122 stores image data forwarded from the external terminals 2A-2D or identification information regarding image data as described below.

The control unit 123 performs control in order to cause the image data forwarded from any of the external terminals 2A-2D to be printed out by the print unit 13, to detect the remaining storage capacity of the storage device 122 and to switch between storage of the output image data itself and storage of the identification information regarding the output image data, based on the detection results. Furthermore, it also performs control in accordance with an instruction for re-printing that is input by the user via the user interface 11 in order to cause image data that has already been printed out to be printed once more. For this re-printing, where the image data is stored in the storage device 122, the stored image data is output to the print unit 13. Where the identification information regarding the image data is stored, the corresponding external terminal 2A-2D is instructed to re-create the image data.

Moreover, when issuing an instruction for re-creation of image data to an external terminal 2A-2D, the control unit 123 detects whether the power supply to the external terminal 2A-2D is ON or OFF, and where the power supply is OFF, the control unit 123 turns it ON to begin the operation of the external terminal, and then causes the image data to be re-created. After the image data has been re-created, the power supply to the external terminal is turned OFF.

The output interface 124 outputs image data to the print unit 13.

The print unit 13 prints out image data output from the print controller 12 onto a sheet of paper, and in this embodiment, a construction in which printing is performed using the electrophotographic method is adopted. The image formation method used by the print unit is not limited to the electrophotographic method. Any other method, such as the inkjet method or the thermal method, may be used.

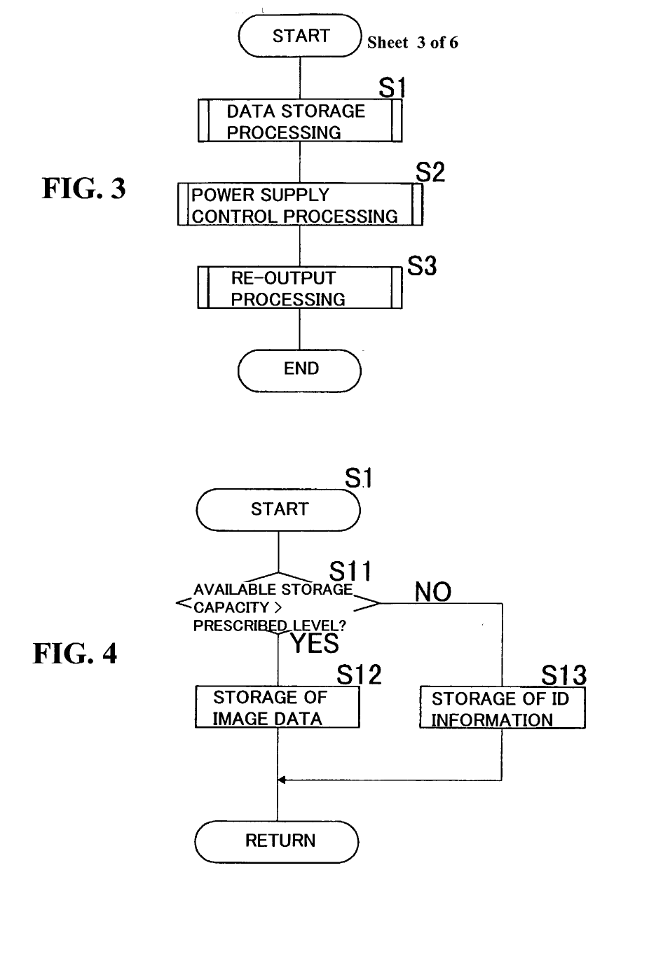

The processing performed when image data is re-printed in the print system shown in FIGS. 1 and 2 will now be described with reference to FIGS. 3 through 6. This processing is executed by the control unit 123 of the print controller 12 based on a software program stored in the storage device 122 or the like.

FIG. 3 is a flow chart showing the main routine. After output of image data has been completed, data storage processing is performed in S1, power supply control processing regarding the external terminal is performed in S2, and image data re-output processing is performed in S3, whereupon the routine ends.

FIG. 4 is a flow chart showing the image data storage processing subroutine. In S11, the control unit 123 determines whether or not the available storage capacity of the storage device 122 exceeds a prescribed level, and where it exceeds the prescribed level (YES in S11), because this indicates the existence of sufficient unused storage space, the control unit 123 causes the output image data itself to be stored in the storage device 122 in S12 and returns to the main routine. Where the available storage capacity does not exceeds the prescribed level (NO in S11), because this indicates the absence of sufficient usable storage space, the control unit 123 causes not the image data itself but the identification information regarding the image data to be stored in the storage device 122 in S13, whereupon it returns to the main routine.

This identification information regarding image data is used as information by which to specify the original file for the image data and/or the application software program used for the creation of the file when the image data is to be re-created by the external terminal 2A-2D. Such identification information includes, as shown in FIG. 7, information regarding the sender external terminal from which the image data was sent (the external terminal 2A in this example), information regarding the base data that corresponds to the image data (file name ‘investigation report’ in this example), and information regarding the application software program used to create the base data corresponding to the image data (Microsoft® Excel 2000 (product name) in this example). By using such sender information, base data information and application software program information as the identification information regarding the image data, instruction to the external terminal to re-create image data and identification of the file on the side of the external terminal are made easy. Identification information is not limited to the items of information mentioned above, however.

Since this identification information is much smaller in terms of data size than image data, it consumes much less storage space in the storage device 122 of the print controller 12 or the storage device 24 of the external terminal 2A-2D than the image data itself. Therefore, storage of identification information offers the same practical effect as storage of a large number of image data sets, enabling the number of image data sets that can be re-output to be increased.

For example, to provide an explanation using a monochrome 600 dpi printer as an example, in order to store image data for an A4-size sheet (7015 dots×4960 lines), approximately 33 megabytes of (=7015×4960) storage capacity are needed in the storage device, but the three-line text data comprising the identification information shown in FIG. 7 takes up only 2 kilobytes, which requires much less storage space. Generally, image data is compressed using the JPEG format or the like when stored, but even when compressed, if the image data is monochrome data, the compressed monochrome data is only approximately 1/20 the size of the original image data, and is never less than the size of three lines of text data.

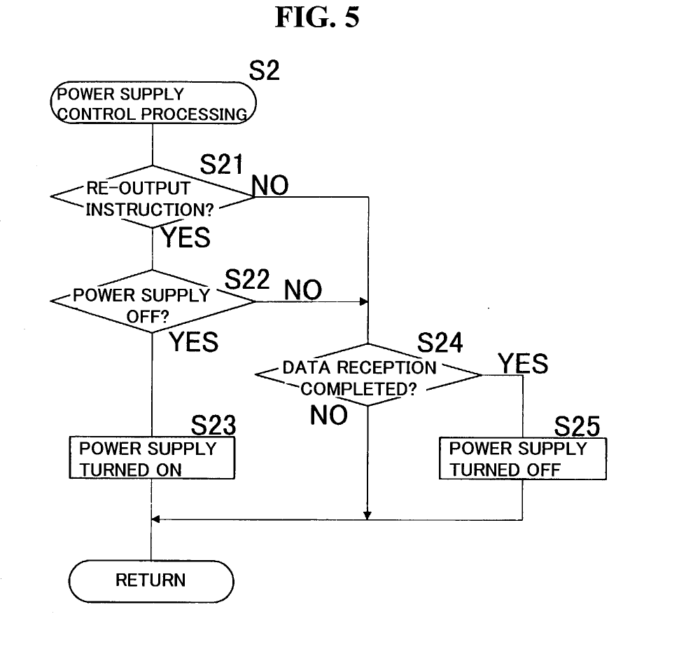

FIG. 5 is a flow chart showing the power supply control processing subroutine S2 shown in FIG. 3 that is executed in connection with the external terminal 2A-2D.

In S21, it is determined whether or not an instruction to re-output image data that has previously been printed has been input by the user via the user interface 11 of the printer 1. If such an instruction has been input (YES in S21), it is determined in S22 whether or not the power supply to the corresponding external terminal 2A-2D is OFF. Where the power supply to the corresponding external terminal is OFF (YES in S22), the power supply to the external terminal 2A-2D is turned ON in S23, and the control unit 123 returns to the main routine. Where an instruction to re-output image data that has previously been printed has not been input (NO in S21) or the power supply to the external terminal 2A-2D is not OFF (NO in S22), it is determined in S24 whether or not data has been completely received. Where data has been completely received (YES in S24), the power supply to the external terminal 2A-2D is turned OFF in S25, whereupon the control unit 123 returns to the main routine. Where data has not been completely received (NO in S24), the control unit 123 returns to the main routine without further processing.

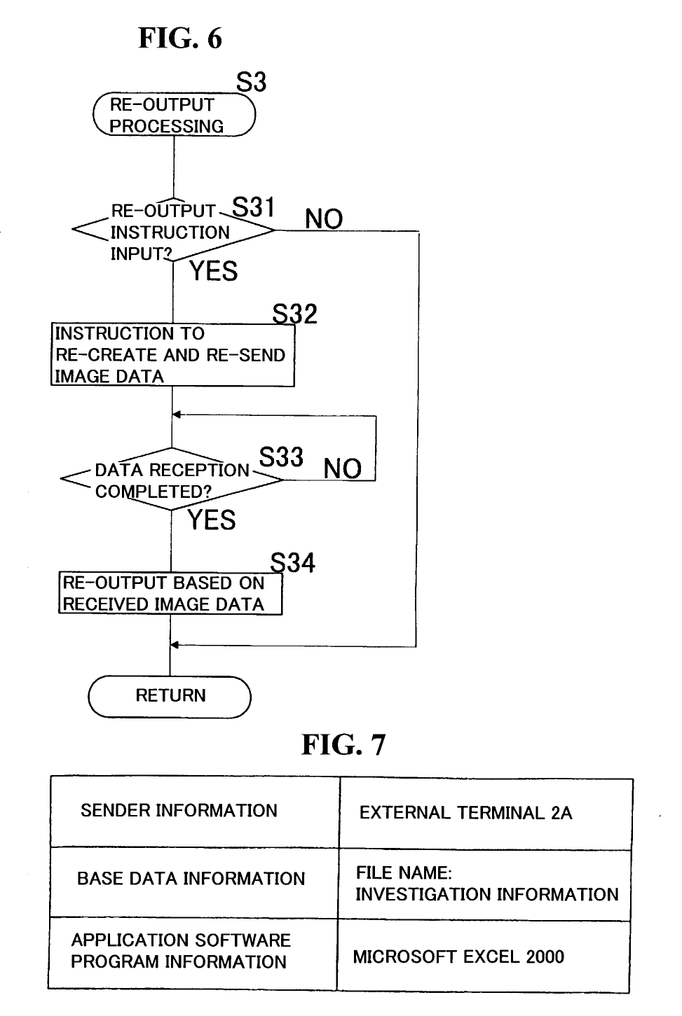

FIG. 6 is a flow chart showing the re-output processing subroutine S3 shown in FIG. 3.

It is determined in S31 whether or not an instruction to re-output image data has been input by the user via the user interface 11 of the printer 1. Where such an instruction has not been input (NO in S31), the control unit 123 returns to the main routine without further processing. If such an instruction has been input (YES in S31), the control unit 123 instructs the external terminal 2A-2D that created the image data to re-create and re-send the image data in S32.

It is then determined in S33 whether or not the image data re-created by and re-sent from the external terminal 2A-2D has been completely received. If it has not (NO in S33), the control unit 123 waits until the image data is completely received. Where the image data has been completely received (YES in S33), the control unit 123 outputs the received image data to the print unit 13 in S34 and causes it to be printed by the print unit 13, whereupon the control unit 123 returns to the main routine.

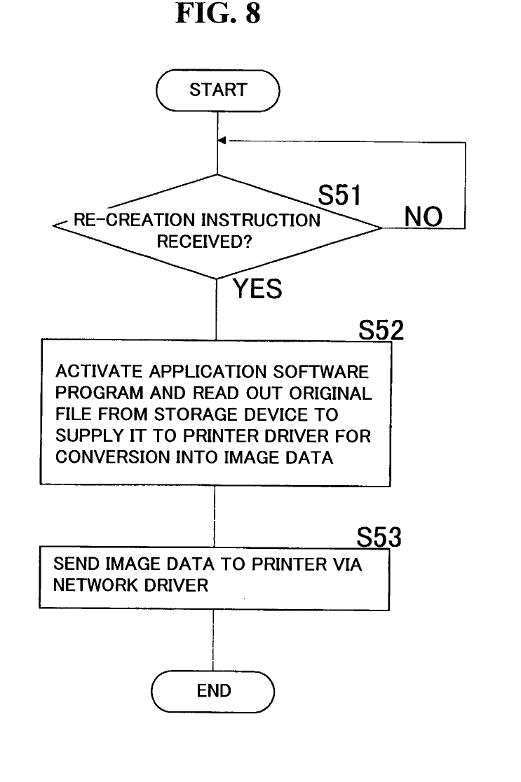

FIG. 8 is a flow chart showing the operation of an external terminal 2A-2D that has received an instruction from the print controller 12 to re-create and re-send image data. This processing is executed by the control unit 22 based on a software program stored in the storage device 24 or the like.

The control unit 22 determines in S51 whether or not an instruction to re-create and re-send image data has been received from the print controller 12. If such an instruction has not been received (NO in S51), the control unit 22 waits until one is received. When such an instruction is received (YES in S51), the corresponding application software program is activated in the application operation unit 23 in S52, the original file (base data) for the image data is read out from the storage device 24, and the file thus read out is supplied to the printer driver 25 for conversion into image data.

The image data obtained as a result of conversion is then supplied to the network driver 26 and sent to the printer 1, whereupon the routine ends.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

The embodiment described above described a situation in which, for example, the print controller 12 which serves as an image processing device is included in the printer 1 which serves as an image forming apparatus, but the print controller 12 need not be included in the printer 1, and may be connected to the network 3 independently from the printer 1.

What is claimed is:

1. An image processing device comprising:
receiving means for receiving from an external terminal image data obtained as a result of conversion of base data created using an application software program into a prescribed output format;
output means for outputting the received image data;
a storage device for storing identification information regarding the image data output by the output means;
re-creation instruction means for, when an instruction to re-output the image data is input, instructing the external terminal to re-create the image data via activation of the application software program based on the identification information; and
output control means for causing the receiving means to receive the image data re-created by the external terminal based on the instruction from the re-creation instruction means and for causing the output means to output the image data.

2. An image processing device according to claim 1, wherein the image data output by the output means comprises print data, and the identification information comprises identification information for the output print data.

3. An image processing device according to claim 2, wherein the identification information includes information regarding the sender of the image data, information regarding the base data, and information regarding the application software program used to create the base data.

4. An image processing device according to claim 1, further comprising detection means for detecting the remaining storage capacity of the storage device and switching means for switching between storage of the output image data itself or storage of identification information regarding the output image data based on the detection result obtained by the detection means.

5. An image processing device according to claim 1, further comprising:
power supply detection means for detecting whether the power supply to the external terminal is ON or OFF; and
power supply control means for, when the power supply to the external terminal is OFF, turning it ON to begin the operation of the external terminal, and for turning the power supply to the external terminal OFF after image data re-created by the external terminal based on the instruction from the re-creation instruction means has been received by the receiving means.

6. An image forming apparatus comprising:
an image processing device according to claim 1; and
a printer for printing out image data output from the output means of the image processing device.

7. An image processing system including an image processing device and an external terminal that are mutually interconnected over a network, wherein
the external terminal includes:
base data creation means for creating base data using an application software program;
image data conversion means for converting the base data into image data having a prescribed output format; and
re-creation execution means for executing the re-creation of the image data based on an instruction from the image processing device, and
the image processing device includes:
receiving means for receiving the image data from the external terminal;
output means for outputting the received image data;
a storage device for storing identification information regarding the image data output by the output means;
re-creation instruction means for, when an instruction to re-output the image data is input, instructing the re-creation execution means of the external terminal to re-create the image data based on the identification information; and
output control means for causing the receiving means to receive the image data re-created by the external terminal and causing the output means to output the image data.

8. An image processing method for use with an image processing device, comprising the steps of
(1) receiving from an external terminal image data obtained as the result of conversion of base data created using an application software program into a prescribed output format;
(2) outputting the received image data;
(3) storing identification information regarding the output image data in a storage device;
(4) instructing the external terminal-to re-create the image data based on the identification information by activating the application software program when an instruction to re-output the image data is input;
(5) receiving the image data re-created by the external terminal based on the instruction issued in step (4); and
(6) outputting the image data received in step (5).

9. An image processing method according to claim 8, wherein the image data output in step (2) comprises print data, and the identification information comprises identification information for the output print data.

10. An image processing method according to claim 9, wherein the identification information includes information regarding the sender of the image data, information regarding the base data, and information regarding the application software program used to create the base data.

11. An image processing method according to claim 8, further comprising a step of detecting the remaining storage capacity of the storage device and a step of switching between storage of the output image data itself or storage of identification information regarding the output image data based on the detection result obtained in the preceding step.

12. An image processing method according to claim 8, further comprising the steps of:
detecting whether the power supply to the external terminal is ON or OFF; and
turning the power supply to the external terminal ON to begin the operation of the external terminal when the power supply to the external terminal is OFF, and turning the power supply to the external terminal OFF after image data re-created by the external terminal based on the instruction issued in step (4) has been received in step (5).

13. A software program for causing a computer to execute processing comprising the steps of:
(1) receiving from an external terminal image data obtained as the result of conversion of base data created using an application software program into a prescribed output format;
(2) outputting the received image data;
(3) storing identification information regarding the output image data in a storage device;
(4) instructing the external terminal to re-create the image data based on the identification information by activating the application software program when an instruction to re-output the image data is input;
(5) receiving the image data re-created by the external terminal based on the instruction issued in step (4); and
(6) outputting the image data received in step (5).

14. A software program according to claim 13, wherein the image data output in step (2) comprises print data, and the identification information comprises identification information for the output print data.

15. A software program according to claim 14, wherein the identification information includes information regarding the sender of the image data, information regarding the base data, and information regarding the application software program used to create the base data.

16. A software program according to claim 13, wherein the processing further comprises a step of detecting the remaining storage capacity of the storage device and a step of switching between storage of the output image data itself or storage of identification information regarding the output image data based on the detection result obtained in the preceding step.

17. A software program according to claim 13, wherein the processing further comprises:
a step of detecting whether the power supply to the external terminal is ON or OFF; and
a step of turning the power supply to the external terminal ON to begin the operation of the external terminal when the power supply to the external terminal is OFF, and turning the power supply to the external terminal OFF after image data re-created by the external terminal based on the instruction issued in step (4) has been received in step (5).

18. A recording medium storing a software program according to claim 13.
